(19) United States
(12) Patent Application Publication
(10) Pub. No.: US 2006/0178464 A1
(43) Pub. Date: Aug. 10, 2006

(54) Polyolefin nanocomposite compositions

(75) Inventors: Vu A. Dang, Bear, DE (US); Tam T.M. Phan, Bear, DE (US)

Correspondence Address: BASELL USA INC., INTELLECTUAL PROPERTY, 912 APPLETON ROAD, ELKTON, MD, 21921, US

(73) Assignee: Basell Poliolefine Italia s.r.l., Milan (IT)

(21) Appl. No.: 10/550,140

(22) PCT Filed: Mar. 15, 2004
(86) PCT No.: PCT/IB04/00893

§ 371 Date: Sep. 21, 2005

Related U.S. Application Data
(60) Provisional application No. 60/457,728, filed on Mar. 26, 2003.

(51) Int. Cl. C08K 9/04

(52) U.S. Cl. 524/445

(57) ABSTRACT

A nanocomposite composition having improved mechanical properties containing, A. about 5 to about 20 wt % of a compatibilizing dispersant chosen from an olefin polymer peroxide, an ionomer of an olefin polymer peroxide, a grafted olefin polymer peroxide, an mixtures thereof; B. about 1 to about 15 wt % of a smectite clay; and C. about 65 to about 94 wt % of an olefin polymer material; wherein the sum of components A+B+C is equal to 100 wt %.

The present invention relates to polyolefin nanocomposite compositions containing smectite clays, polymeric peroxide compatibilizing dispersants, and olefin polymer material, and articles made therefrom.

Layered clay minerals such as smectite clays are composed of coplanar, closely-spaced silicate layers, and are quite polar. It is known that such clays, e.g., sodium and calcium montmorillonite, can be treated with various types of swelling agents such as organic ammonium ions, to intercalate the swelling agent molecules between adjacent, planar silicate layers, thereby substantially increasing the interlayer spacing. In such a condition, substantially less shear is required to separate the platelet layers from each other. When sufficient shear is applied to the intercalated particles to overcome the forces holding the layers together, de-lamination of the clay particles occurs, and diminuted clay particles are obtained. Such particles are referred to as exfoliated clay particles. When the exfoliated clay particles are dispersed in the matrices of a polymer material, the resulting composition is referred to as a nanocomposite composition. Such compositions have been found to substantially improve one or more properties of the polymer, such as modulus and/or high temperature characteristics. In polymer nanocomposite compositions, the inorganic, polar clay is incompatible with the organic, non-polar polymer. There is thus an incentive to enhance the compatibility and dispersion of the inorganic clay within the polymer matrix, and to maintain the thermodynamic stability of such a dispersion, once established, in order to take advantage of an enhancement in mechanical properties above and beyond what is normally realized by conventional filled polymers. Further, it is known that the nucleation of olefin polymer material also enhances its mechanical properties. There is therefore, also an incentive to improve the nucleation of the olefin polymer matrix within which the clay is dispersed.

It is known that polyolefin nanocomposite compositions generally make use of materials such as maleic anhydride-grafted polyolefins to compatibilize and disperse smectite clay in the polymer matrix. For example, U.S. Pat. No. 6,423,768 discloses polymer-organoclay compositions that include compatibilizers such as dicarboxylic acids, tricarboxylic acids and cyclic carboxylic acid anhydrides. U.S. Pat. No. 6,407,155 discloses nanocomposite compositions containing coupling agents such as silanes, titanates, aluminates, zirconates; and an omnium ion spacing/compatibilizing agent. U.S. Pat. No. 6,451,897 discloses nanocomposite compositions containing a graft copolymer of a propylene polymer material and a smectite-type clay that has been treated with a swelling agent. However, there continues to be a need for compatibilizing dispersants that enhance the mechanical properties of olefin polymer nanocomposite compositions through improved compatibilization and dispersion of the clay within the olefin polymer matrix, and improvement in the nucleation of the olefin polymer material.

It has unexpectedly been found that the addition of specific polymeric peroxide compatibilizing dispersants improve the mechanical properties of nanocomposite compositions, and enhance the nucleation of the olefin polymer material.

The present invention relates to polyolefin nanocomposite compositions comprising:
A. about 5 to about 20 wt % of a compatibilizing dispersant chosen from an olefin polymer peroxide, an ionomer of an olefin polymer peroxide, a grafted olefin polymer peroxide, and mixtures thereof;
B. about 1 to about 15 wt % of a smectite clay; and
C. about 65 to about 94 wt % of an olefin polymer material.

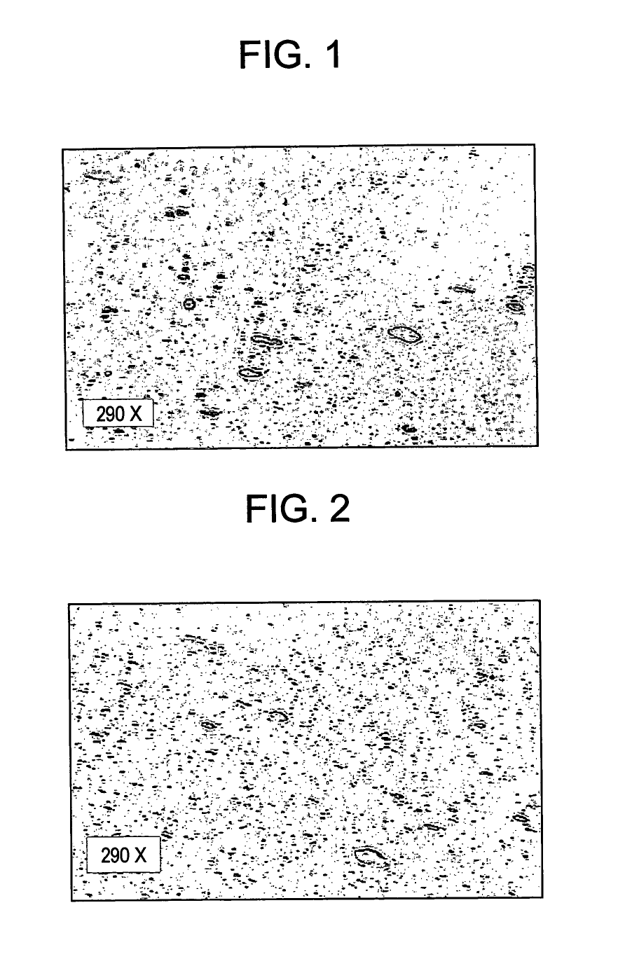

FIG. 1 is a transmitted light image of a 97/3 blend of a propylene homopolymer and montmorillonite clay, shown at a 290× magnification.

FIG. 2 is a transmitted light image of an 87/10/3 blend of a propylene homopolymer, polymeric peroxide and montmorillonite clay, according to the present invention, shown at a 290× magnification.

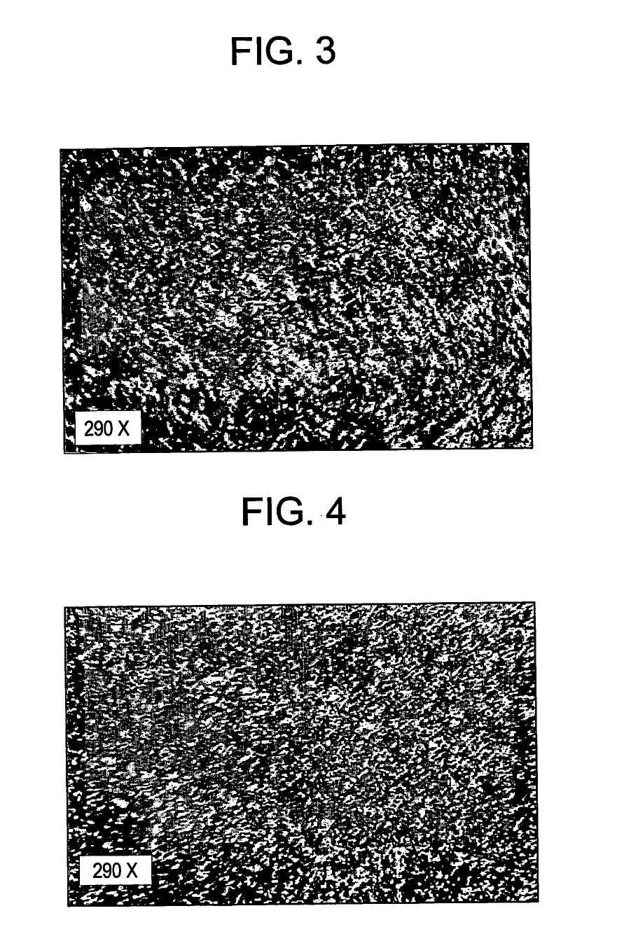

FIG. 3 is a cross-polarized light image of a 97/3 blend of a propylene homopolymer and montmorillonite clay, shown at a 290× magnification.

FIG. 4 is a cross-polarized light image of an 87/10/3 blend of a propylene homopolymer, polymeric peroxide and montmorillonite clay, according to the present invention, shown at a 290× magnification.

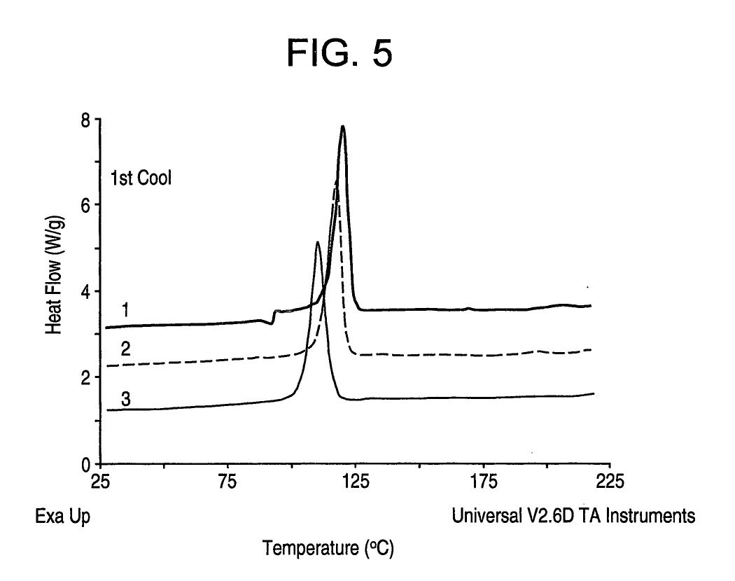

FIG. 5 is a DSC cooling scan for: a 97/3 blend of a propylene homopolymer and montmorillonite clay; an 87/10/3 blend of a propylene homopolymer, polymeric peroxide and montmorillonite clay, according to the present invention; an 87/5/5/3 blend of a propylene homopolymer, a polymeric peroxide, a maleated propylene polymer, and montmorillonite clay, shown at a 290× magnification.

Smectite clays are layered clay minerals composed of silicate layers with a thickness on a nanometer scale, having different properties than the kaolin clays conventionally used as fillers in polymer materials. Suitable smectite clay in the compositions of the invention include, for example, montmorillonite, nontronite, beidellite, volkonskoite, hectorite, saponite, sauconite, sobockite, stevensite and svinfordite, where the space between silicate layers is typically about 17 to about 36 angstroms, measured by small angle X-ray scattering. Montmorillonite is preferred.

The smectite clay mineral can be untreated, or it can be modified with a swelling agent to increase the interlayer spacing. The expansion of the interlayer distance of the layered silicate facilitates the intercalation of the clay with other materials. The organic swelling agent used to treat the clay is typically a quaternary ammonium compound, excluding pyridinium ion, such as, for example, poly(propylene glycol)bis(2-aminopropyl ether), poly(vinylpyrrolidone), dodecylamine hydrochloride, octadecylamine hydrochloride, dodecylpyrrolidone, or mixtures thereof. The clay can be swelled with water before introducing the quaternary ammonium ion.

The smectite clay may be ground to a desired particle size range prior to mixing with the olefin polymer and polymeric peroxide. The smectite clays are present in an amount from about 1 to about 15 wt % based on the total weight of the composition. Preferably, the smectite clays are present in an amount from about 2 to about 10 wt %, more preferably in an amount from about 2 to about 5 wt %.

Polymer materials suitable as the starting material for making the polymeric peroxides of the invention, and for the olefin polymer material that is combined with the smectite clay and compatibilizing dispersants of the invention, include propylene polymer materials, ethylene polymer materials, butene-1 polymer materials, and mixtures thereof.

When a propylene polymer material is used as the olefin polymer material or as the starting material for the polymeric peroxide, the propylene polymer material can be:
(A) a homopolymer of propylene having an isotactic index greater than about 80%, preferably about 90% to about 99.5%;
(B) a random copolymer of propylene and an olefin chosen from ethylene and C₄-C₁₀ α-olefins, containing about 1 to about 30 wt % of said olefin, preferably about 1 to 20 wt %, and having an isotactic index greater than about 60%, preferably greater than about 70%;
(C) a random terpolymer of propylene and two olefins chosen from ethylene and C₄-C₈ α-olefins, containing about 1 to about 30 wt % of said olefins, preferably about 1 to 20 wt %, and having an isotactic index greater than about 60%, preferably greater than about 70%;
(D) an olefin polymer composition comprising:
   (i) about 10 parts to about 60 parts by weight, preferably about 15 parts to about 55 parts, of a propylene homopolymer having an isotactic index of at least about 80%, preferably about 90 to about 99.5%, or a crystalline copolymer chosen from (a) propylene and ethylene, (b) propylene, ethylene and a C₄-C₈ α-olefin, and (c) propylene and a C₄-C₈ α-olefin, the copolymer having a propylene content of more than about 85% by weight, preferably about 90% to about 99%, and an isotactic index greater than about 60%;
   (ii) about 3 parts to about 25 parts by weight, preferably about 5 parts to about 20 parts, of a copolymer of ethylene and propylene or a C₄-C₈ α-olefin that is insoluble in xylene at ambient temperature; and
   (iii) about 10 parts to about 80 parts by weight, preferably about 15 parts to about 65 parts, of an elastomeric copolymer chosen from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene, and containing less than about 70% by weight, preferably about 10% to about 60%, most preferably about 12% to about 55%, of ethylene and being soluble in xylene at ambient temperature and having an intrinsic viscosity of about 1.5 to about 4.0 dl/g;
      the total of (ii) and (iii), based on the total olefin polymer composition being from about 50% to about 90%, and the weight ratio of (ii)/(iii) being less than about 0.4, preferably about 0.1 to about 0.3, wherein the composition is prepared by polymerization in at least two stages;
(E) a thermoplastic olefin comprising:
   (i) about 10% to about 60%, preferably about 20% to about 50%, of a propylene homopolymer having an isotactic index of at least about 80%, preferably about 90 to about 99.5% or a crystalline copolymer chosen from (a) ethylene and propylene, (b) ethylene, propylene and a C₄-C₈ x-olefin, and (c) ethylene and a C₄-C₈ α-olefin, the copolymer having a propylene content greater than about 85% and an isotactic index of greater than about 60%;
   (ii) about 20% to about 60%, preferably about 30% to about 50%, of an amorphous copolymer chosen from (a) ethylene and propylene, (b) ethylene, propylene, and a C₄-C₈ α-olefin, and (c) ethylene and an α-olefin, the copolymer optionally containing from about 0.5% to about 10% of a diene, and containing less than about 70% ethylene and being soluble in xylene at ambient temperature; and
   (iii) about 3% to about 40%, preferably about 10% to about 20%, of a copolymer of ethylene and propylene or an α-olefin that is insoluble in xylene at ambient temperature; and
(F) mixtures thereof.

When an ethylene polymer material is used as the olefin polymer material or as the starting material for the polymeric peroxide, the ethylene polymer material is chosen from (a) homopolymers of ethylene, (b) random copolymers of ethylene and an alpha-olefin chosen from C₃₋₁₀ alpha-olefins, (c) random terpolymers of ethylene and said alpha-olefins, and (d) mixtures thereof. The C₃₋₁₀ alpha-olefins include the linear and branched alpha-olefins such as, for example, propylene, 1-butene, isobutylene, 1-pentene, 3-methyl-1-butene, 1-hexene, 3,4-dimethyl-1-butene, 1-heptene, 3-methyl-1-hexene, 1-octene and the like.

When the ethylene polymer is an ethylene homopolymer, it typically has a density of about 0.89 g/cm³ or greater, and when the ethylene polymer is an ethylene copolymer with a C₃₋₁₀ alpha-olefin, it typically has a density of about 0.91 g/cm³ to less than about 0.94 g/cm³. Suitable ethylene copolymers include ethylene/butene-1, ethylene/hexene-1, ethylene/octene-1 and ethylene/4-methyl-1-pentene. The ethylene copolymer can be a high density ethylene copolymer or a short chain branched linear low density ethylene copolymer (LLDPE), and the ethylene homopolymer can be a high density polyethylene (HDPE) or a low density polyethylene (LDPE). Typically the LLDPE and LDPE have densities of about 0.910 g/cm³ to less than about 0.940 g/cm³ and the HDPE and high density ethylene copolymer have densities of greater than about 0.940 g/cm³, usually about 0.95 g/cm³ or greater. In general, ethylene polymer materials having a density from about 0.89 to about 0.97 g/cm³ are suitable for use in the practice of this invention. Preferably, the ethylene polymers are LLDPE and HDPE having a density from about 0.89 to about 0.97 g/cm³.

When a butene-1 polymer material is used as the olefin polymer material or as the starting material for the polymeric peroxide, the butene-1 polymer material is chosen from a normally solid, high molecular weight, predominantly crystalline butene-1 polymer material chosen from:
(1) a homopolymer of butene-1;
(2) a copolymer or terpolymer of butene-1 with a non-butene alpha-olefin comonomer content of about 1 to about 15 mole %, preferably about 1 to about 10 mole %; and
(3) mixtures thereof.

Typically the non-butene alpha-olefin comonomer is ethylene, propylene, a C₅₋₈ alpha-olefin or mixtures thereof.

The useful polybutene-1 homo or copolymers can be isotactic or syndiotactic and have a melt flow rate (MFR) from about 0.5 to about 150, preferably from about 0.5 to about 100, and most preferably from about 0.5 to about 75 g/10 min.

These poly-1-butene polymers, their methods of preparation, and their properties are known in the art. An exemplary reference containing additional information on polybutylene-1 is U.S. Pat. No. 4,960,820.

Suitable polybutene-1 polymers can be obtained, for example, by Ziegler-Natta low-pressure polymerization of butene-1, e.g. by polymerizing butene-1 with catalysts of TiCl₃ or TiCl₃—AlCl₃ and Al(C₂H₅)₂Cl at temperatures of about 10 to about 100° C., preferably about 20 to about 40° C., e.g., according to the process described in DE-A-1,570,353. It can also be obtained, for example, by using TiCl₄—MgCl₂ catalysts. High melt indices are obtainable by further processing of the polymer by peroxide cracking or visbreaking, thermal treatment or irradiation to induce chain scissions leading to a higher MFR material.

Preferably, the polybutene-1 contains up to about 15 mole % of copolymerized ethylene or propylene, but more preferably it is a homopolymer, for example, Polybutene PB0300 homopolymer marketed by Basell USA Inc. This polymer is a homopolymer with a melt flow of 11 g/10 min. at 230° C. and 2.16 kg and a weight average molecular weight of 270,000 dalton.

Preferably, the polybutene-1 homopolymer has a crystallinity of at least about 55% by weight measured with wide-angle X-ray diffraction after 7 days. Typically the crystallinity is less than about 70%, preferably less than about 60%.

Preferably, the olefin polymer material is a propylene polymer material. More preferably, the olefin polymer material is a crystalline homopolymer of propylene having an isotactic index greater than about 80%, preferably about 90% to about 99.5%.

The olefin polymer material is present in an amount from about 65 to about 94 wt % based on the total weight of the composition. Preferably, the olefin polymer material is present in an amount from about 75 to about 91 wt %, more preferably in an amount from about 83 to about 90 wt %.

The compatibilizing dispersants are chosen from polymeric peroxides, ionomers of a polymer peroxide, grafted polymeric peroxides, and mixtures thereof. The polymeric peroxides contain greater than 1 mmol total peroxide per kilogram of the polymeric peroxide. Preferably, the polymeric peroxides contain from greater than about 1 to about 200 mmol total peroxide per kilogram of polymeric peroxide, more preferably from about 5 to about 100 mmol total peroxide per kilogram of polymeric peroxide.

In one method for preparing the polymer peroxides, the olefin polymer starting material is first exposed to high-energy ionizing radiation under a blanket of inert gas, preferably nitrogen. The ionizing radiation should have sufficient energy to penetrate the mass of polymer material being irradiated to the extent desired. The ionizing radiation can be of any kind, but preferably includes electrons and gamma rays. More preferred are electrons beamed from an electron generator having an accelerating potential of about 500 to about 4,000 kilovolts. Satisfactory results are obtained at a dose of ionizing radiation of about 0.1 to about 15 megarads (“Mrad”), preferably about 0.5 to about 9.0 Mrad.

The term “rad” is usually defined as that quantity of ionizing radiation that results in the absorption of 100 ergs of energy per gram of irradiated material regardless of the source of the radiation using the process described in U.S. Pat. No. 5,047,446. Energy absorption from ionizing radiation is measured by the well-known convention dosimeter, a measuring device in which a strip of polymer film containing a radiation-sensitive dye is the energy absorption sensing means. Therefore, as used in this specification, the term “rad” means that quantity of ionizing radiation resulting in the absorption of the equivalent of 100 ergs of energy per gram of the polymer film of a dosimeter placed at the surface of the olefin material being irradiated, whether in the form of a bed or layer of particles, or a film, or a sheet.

The irradiated olefin polymer material is then oxidized in a series of steps. The first treatment step consists of heating the irradiated polymer in the presence of a first controlled amount of active oxygen greater than about 0.004% by volume but less than about 15% by volume, preferably less than about 8% by volume, more preferably less than about 5% by volume, and most preferably from about 1.3% to about 3.0% by volume, to a first temperature of at least about 25° C. but below the softening point of the polymer, preferably about 25° C. to about 140° C., more preferably about 25° C. to about 100° C., and most preferably about 40° C. to about 80° C. Heating to the desired temperature is accomplished as quickly as possible, preferably in less than about 10 minutes. The polymer is then held at the selected temperature, typically for about 5 to about 90 minutes, to increase the extent of reaction of the oxygen with the free radicals in the polymer. The holding time, which can be determined by one skilled in the art, depends upon the properties of the starting material, the active oxygen concentration used, the irradiation dose, and the temperature. The maximum time is determined by the physical constraints of the fluid bed.

In the second treatment step, the irradiated polymer is heated in the presence of a second controlled amount of oxygen greater than about 0.004% but less than about 15% by volume, preferably less than about 8% by volume, more preferably less than about 5% by volume, and most preferably from about 1.3% to about 3.0% by volume, to a second temperature of at least about 25° C. but below the softening point of the polymer. Preferably, the second temperature is from about 100° C. to less than the softening point of the polymer, and greater than the first temperature of the first step. The polymer is then held at the selected temperature and oxygen concentration conditions, typically for about 90 minutes, to increase the rate of chain scission and to minimize the recombination of chain fragments so as to form long chain branches, i.e., to minimize the formation of long chain branches. The holding time is determined by the same factors discussed in relation to the first treatment step.

In the optional third step, the oxidized olefin polymer material is heated under a blanket of inert gas, preferably nitrogen, to a third temperature of at least about 80° C. but below the softening point of the polymer, and held at that temperature for about 10 to about 120 minutes, preferably about 60 minutes. A more stable product is produced if this step is carried out. It is preferred to use this step if the irradiated, oxidized olefin polymer material is going to be stored rather than used immediately, or if the radiation dose that is used is on the high end of the range described above. The polymer is then cooled to a fourth temperature of about 70° C. over a period of about 10 minutes under a blanket of inert gas, preferably nitrogen, before being discharged from the bed. In this manner, stable intermediates are formed that can be stored at room temperature for long periods of time without further degradation.

A preferred method of carrying out the treatment is to pass the irradiated propylene polymer through a fluid bed assembly operating at a first temperature in the presence of a first controlled amount of oxygen, passing the polymer through a second fluid bed assembly operating at a second temperature in the presence of a second controlled amount of oxygen, and then maintaining the polymer at a third temperature under a blanket of nitrogen, in a third fluid bed assembly. In commercial operation, a continuous process using separate fluid beds for the first two steps, and a purged, mixed bed for the third step is preferred. However, the process can also be carried out in a batch mode in one fluid bed, using a fluidizing gas stream heated to the desired temperature for each treatment step. Unlike some techniques, such as melt extrusion methods, the fluidized bed method does not require the conversion of the irradiated polymer into the molten state and subsequent re-solidification and comminution into the desired form. The fluidizing medium can be, for example, nitrogen or any other gas that is inert with respect to the free radicals present, e.g., argon, krypton, and helium.

The concentration of peroxide groups formed on the polymer can be controlled easily by varying the radiation dose during the preparation of the irradiated polymer and the amount of oxygen to which such polymer is exposed after irradiation. The oxygen level in the fluid bed gas stream is controlled by the addition of dried, filtered air at the inlet to the fluid bed. Air must be constantly added to compensate for the oxygen consumed by the formation of peroxides in the polymer.

As used in this specification, the expression “room temperature” or “ambient” temperature means approximately 25° C. The expression “active oxygen” means oxygen in a form that will react with the irradiated olefin polymer material. It includes molecular oxygen, which is the form of oxygen normally found in air. The active oxygen content requirement of this invention can be achieved by replacing part or all of the air in the environment by an inert gas such as, for example, nitrogen.

In another method for preparing the polymeric peroxides, an olefin polymer starting material is treated with about 0.1 to about 4 wt % of an organic peroxide initiator while adding a controlled amount of active oxygen so that the olefin polymer material is exposed to greater than about 0.004% by volume, but less than about 15% by volume of active oxygen, preferably less than about 8%, more preferably less than about 5% by volume, and most preferably about 1.3% to about 3% by volume, at a temperature of at least about 25° C. but below the softening point of the polymer, preferably about 25° C. to about 140° C. In a second step, the polymer is then heated to a temperature of at least about 25° C. up to the softening point of the polymer (140° C. for a propylene homopolymer), preferably from about 100° C. to less than the softening point of the polymer, at an oxygen concentration that is within the same range as in the first treatment step. The total reaction time is typically up to three hours. After the oxygen treatment, the polymer is treated at a temperature of at least about 80° C. but below the softening point of the polymer, typically for one hour, in an inert atmosphere such as nitrogen to quench any active free radicals.

Suitable organic peroxides include acyl peroxides, such as benzoyl and dibenzoyl peroxides; dialkyl and aralkyl peroxides, such as di-tert-butyl peroxide, dicumyl peroxide; cumyl butyl peroxide; 1,1,-di-tert-butylperoxy-3,4,4-trimethylcyclohexane; 2,5-dimethyl-1,2,5-tri-tert-butylperoxyhexane, and bis(alpha-tert-butylperoxy isopropylbenzene), and peroxy esters such as bis(alpha-tert-butylperoxy pivalate; tertbutylperbenzoate; 2,5-dimethylhexyl-2,5-di(perbenzoate); tert-butyl-di(perphthalate); tert-butylperoxy-2-ethylhexanoate, and 1,1-dimethyl-3-hydroxybutylperoxy-2-ethyl hexanoate, and peroxycarbonates such as di(2-ethylhexyl) peroxy dicarbonate, di(n-propyl)peroxy dicarbonate, and di(4-tert-butylcyclohexyl)peroxy dicarbonate. The peroxides can be used neat or in diluent medium, having an active concentration of from about 0.1 to about 6.0 parts per hundred (“pph”), preferably from about 0.2 to about 3.0 pph. Particularly preferred is tert-butyl peroctoate as a 50 weight % dispersion in mineral oil, sold commercially under the brand name of Lupersol PMS.

The polymeric peroxides contain peroxide linkages that degrade during compounding to form various oxygen-containing polar functional groups, e.g., carboxylic acids, ketones, esters and lactones. In addition, the number average and weight average molecular weight of the polymeric peroxide is usually much lower than that of the corresponding olefin polymer used to prepare same, due to the chain scission reactions during irradiation and oxidation.

Preferably, the number average molecular weight and weight average molecular weight of the polymeric peroxide is greater than 10,000. At number average and weight average molecular weight values lower than 10,000, the compatibilizing dispersant will “bloom” at the surface of the finished product.

Preferably, the starting material for preparing the polymeric peroxide compatiblizing dispersant is a propylene polymer material. More preferably, the starting material is a propylene homopolymer having an isotactic index greater than about 80%. The polymeric peroxide is preferably prepared by irradiation followed by exposure to oxygen as described herein above.

Ionomers of the polymeric peroxides can be prepared by methods well known in the art, where at least some of the carboxylic acid groups in the polymeric peroxides are neutralized in a slurry process, a melt process, by reactive extrusion, or by grafting with monomer salts. Melt neutralization is preferred. The basic compounds used for neutralization can be oxides, hydroxides, and salts of metals of Groups IA, IIA, and IIB of the Periodic Table. These compounds include, for example, sodium hydroxide, potassium hydroxide, zinc oxide, sodium carbonate, potassium carbonate, lithium hydroxide, sodium bicarbonate, potassium hydrocarbonate, and lithium carbonate. The Na ionomer of the polymeric peroxide is preferred.

Grafts of the polymeric peroxides can be prepared via reaction of the polymeric peroxides with monomers, by methods well known in the art. For example, U.S. Pat. No. 5,817,707 describes a process for making propylene graft copolymers using a redox initiator system. Suitable monomers include any monomeric vinyl compound wherein the vinyl radical, CH₂═CHR—, in which R is H or methyl, is attached to a straight or branched aliphatic chain having 2-12 carbon atoms or to a substituted or unsubstituted aromatic compound having 6-20 carbon atoms, heterocyclic compound having 4-20 carbon atoms, or alicyclic ring compound having 3-20 carbon atoms in a mono or polycyclic compound. Typical substituent groups can be C₁₋₁₀ straight or branched alkyl, C₁₋₁₀ straight or branched hydroxyalkyl, C₆₋₁₄ aryl, and halo, such as fluorine, chlorine, bromine or iodine. Preferably, the vinyl monomer can be acrylic acid, methacrylic acid, maleic acid, maleic anhydride, vinyl-substituted aromatic compounds having 6-20 carbon atoms, vinyl-substituted heterocyclic compounds having 4-20 carbon atoms, or vinyl-substituted alicyclic compounds having 3-20 carbon atoms. Preferred vinyl monomers include styrene, vinylnaphthalene, vinylpyridine, vinylpyrrolidone, vinylcarbazole, methylstyrenes, methylchlorosyrene, p-teret-butylstyrene, methylvinylpyridine, and ethylvinylpyridine, and (meth)acrylic nitriles and (meth)acrylic acid esters such as acrylonitrile, methacrylonitrile, acrylate esters, such as the methyl, ethyl, hydroxyethyl, 2-ethylhexyl, and butyl acrylate esters, and methacrylate esters, such as the methyl, ethyl, butyl, benzyl, phenylethyl, phenoxyethyl, epoxypropyl, and hydroxypropyl methacrylate esters, and mixtures thereof. Polymeric peroxide compounds grafted with acrylic acid are preferred.

The compatibilizing dispersants are present in an amount from about 5 to about 20 wt % based on the total weight of the composition. Preferably, the compatibilizing dispersants are present in an amount from about 7 to about 15 wt %, more preferably from about 8 to about 12 wt %.

The smectite clay, olefin polymer material and compatibilizing dispersant can be combined at ambient temperature in conventional operations well known in the art; including, for example, drum tumbling, blending, or with low or high speed mixers. The resulting composition is then compounded in the molten state in any conventional manner well known in the art, in batch or continuous mode; for example, by using a Banbury mixer, a kneading machine, or a single or twin screw extruder. The material can then be pelletized.

The nanocomposite compositions of the invention can be used to make articles of manufacture by conventional shaping processes such as melt spinning, casting, vacuum molding, sheet molding, injection molding and extruding. Examples of such articles are components for technical equipment, household equipment, sports equipment, bottles, containers, components for the electrical and electronics industries, automobile components and fibers. They are especially useful for the fabrication of extruded films and film laminates, for example, films for use in food packaging.

Unless otherwise specified, the properties of the olefin polymer materials, and compositions that are set forth in the following examples have been determined according to the test methods set forth in Table I below.

TABLE I

| | |
|---|---|
| Melt Flow Rate (“MFR”) | ASTM D1238, units of dg/min |
| | Propylene polymer material: (230° C.; 2.16 kg) |
| | Ethylene polymer material: (190° C.; 2.16 kg) |
| | Butene-1 polymer material: (230° C.; 2.16 kg) |
| Isotactic Index, (“I.I.”) | Defined as the percent of olefin polymer insoluble in xylene. The weight |
| | percent of olefin polymer soluble in xylene at room temperature is |
| | determined by dissolving 2.5 g of polymer in 250 ml of xylene at room |
| | temperature in a vessel equipped with a stirrer, and heating at 135° C. with |
| | agitation for 20 minutes. The solution is cooled to 25° C. while continuing |
| | the agitation, and then left to stand without agitation for 30 minutes so |
| | that the solids can settle. The solids are filtered with filter paper, the |
| | remaining solution is evaporated by treating it with a nitrogen stream, and |
| | the solid residue is vacuum dried at 80° C. until a constant weight is |
| | reached. These values correspond substantially to the isotactic index |
| | determined by extracting with boiling n-heptane, which by definition |
| | constitutes the isotactic index of polypropylene. |
| Tensile strength @ yield | ASTM D638-89 |
| Flex Modulus | ASTM D790-92 |
| Flex strength @ yield | ASTM D790-92 |
| Heat Distortion | ASTM D648-01B |
| Temperature, (“HDT”) | |
| @ 1.82 MPa | |
| Heat Distortion | ASTM D648-01B |
| Temperature @ 0.46 MPa | |
| Notched Izod Impact at | ASTM-D256-Procedure A |
| 23° C. | |
| Elongation @ Yield | ASTM D638-89 |
| Elongation @ Break | ASTM D638-89 |
| Peroxide Concentration | Quantitative Organic Analysis via Functional Groups, by S. Siggia et al., |
| | 4^{th} Ed., NY, Wiley 1979, pp. 334-42 |

Unless otherwise specified, all references to parts, percentages and ratios in this specification refer to percentages by weight.

### EXAMPLE 1

This example illustrated the preparation of a polymeric peroxide.

A propylene homopolymer having an MFR of 0.32 dg/min and I.I. of 95.6% commercially available from Basell USA Inc. was irradiated at 0.5 Mrad under a blanket of nitrogen. The irradiated polymer was then treated with 1.35% by volume of oxygen at 80° C. for 5 minutes and then with 1.35% by volume of oxygen at 140° C. for an additional 60 minutes. The oxygen was then removed. The polymer was then heated at 140° C. under a blanket of nitrogen for 60 minutes, cooled and collected. The MFR of the resultant polymeric peroxide was 350 dg/min. The peroxide concentration was 9.1 mmole/kg of polymer.

### EXAMPLE 2

This example illustrated the preparation of a polymeric peroxide.

The propylene homopolymer of Example 1 was irradiated according to the procedure of Example 1 and then treated with 1.75% by volume of oxygen at 80° C. for 5 minutes and then with 1.75% by volume of oxygen at 130° C. for another 60 minutes. The oxygen was then removed. The polymer was then heated at 140° C. under a blanket of nitrogen for 60 minutes, cooled and collected. The MFR of the resultant polymeric peroxide was 1200 dg/min. The peroxide concentration was 17.1 mmole/kg of polymer.

### EXAMPLE 3

This example illustrated the preparation of an acrylic acid grafted polymeric peroxide.

The polymeric peroxide of Example 2 was heated in a reactor to 140° C. in an inert atmosphere. Acrylic acid (15 pph) was added to the reactor at the rate 1 pph/min. After monomer addition, the polymer was heated at 140° C. for another 90 minutes. The reactor vent was then opened. A stream of nitrogen was introduced to the reactor to remove any unreacted monomer. After 30 minutes at 140° C., the polymer was cooled and collected. The resulting grafted polymer had an MFR of 1200 dg/nin.

### EXAMPLE 4

This example illustrated the preparation of an ionomer of a polymeric peroxide.

A Na⁺ ionomer of the polymeric peroxide of Example 1 was prepared by neutralization using reactive extrusion in a co-rotating intermeshing Leistritz LSM 34GL twin screw extruder (8 zone plus a die, L/D˜30) with a 3VM screw, commercially available from American Leistritz Extruder Corp., USA. Sodium carbonate salt was used as a base (1 part per hundred parts of the polymer composition). The extrusion conditions were 250 rpm with a throughput of 11.34 kg/hr, using vacuum to remove any by-products. The resultant ionomer had an MFR of 347 dg/min.

### EXAMPLES 6-7, 9-12, 14-16 AND COMPARATIVE EXAMPLES 5, 8 AND 13

In the following Tables and Examples, the following components were used:

Epolene E43: polypropylene grafted with maleic anhydride, commercially available from Eastman Kodak, having an acid number of 40, with approximately 4.5 wt % of total maleic anhydride (“PP-g-MA”).

Clay A: Cloisite 20-montmorillonite clay, commercially available from Southern Clay Products, containing 38 wt % dimethyl, dehydrogenated tallow quaternary ammonium intercalant. The quaternary ammonium concentration is 95 meq/100 g and the basal clay spacing is 24 angstrom (2.4 nm).

Clay B was prepared by suspending 30 g of Montmorillonite K10 clay, commercially available from Aldrich Chemical Company, in 200 ml of deionized water and heating to 60° C. In a separate beaker, 15 g of polypropylene glycol)bis(2-aminopropyl ether) were dissolved in 100 ml of water and heated to 70-75° C. 37% HCl (12 g) was added slowly while stirring. After two hours, the solution was poured into the clay suspension maintained at 60° C. and stirred for two hours at that temperature. The resulting clay was filtered, washed neutral, air dried, and finally dried at 60° C. under vacuum. The final weight was 38 g. Intercalation of the silicate layers of the clay with the organic swelling agent took place by absorption.

All materials, including the clay, were simultaneously dry-blended and bag mixed with stabilizer package, FS210, before extrusion. FS210 is a 1/1 ratio of FS042 alkyl alkoxy amine and Chimassorb 119 hindered amine light stabilizer, both of which are commercially available from Ciba Chemical Specialties Company. Compounding was performed in a co-rotating intermeshing Leistritz LSM 34 GL twin-screw extruder, commercially available from American Leistritz Extruder Corp., USA. Extrusion temperatures were 190° C. for all zones. The actual melt temperature was approximately 180-190° C., with a throughput of 9.1 kg/hr. and screw speed of 200 rpm. Full vacuum was used to remove the volatile organic material from the clay. All materials were injection molded on a 5 oz. Battenfeld injection molding machine available from Battenfeld, Austria, using a melt temperature of 200° C. and mold temperature of 60° C. The injection speed was 2.0 cm/min.

Comparative Example 5 and Examples 6-7 demonstrate the use of a propylene polymeric peroxide compatibilizing dispersant in nanocomposite compositions containing montmorillonite clay and propylene homopolymers commercially available from Basell USA Inc. The composition and physical properties of Comparative Example 5 and Examples 6-7 are set forth in Table II.

TABLE II

| | Comp. | | |
|---|---|---|---|
| | Ex. 5 | Ex. 6 | Ex. 7 |
| Propylene homopolymer, MFR = 4, | 96.8 | 91.8 | 86.8 |
| I.I. = 95%, wt % | | | |
| Polymeric Peroxide of Example 1, | | 5.0 | 10.0 |
| wt % | | | |
| Clay A, wt % | 3.0 | 3.0 | 3.0 |
| Propylene homopolymer, | | | |
| MFR = 400, I.I. = 97.5%, wt % | | | |
| FS210, wt % | 0.2 | 0.2 | 0.2 |
| Physical Properties | | | |
| Notched Izod Impact @ 23° C., | 0.37 | 0.37 | 0.43 |
| J/cm | | | |
| Tensile Strength @ yield, MPa | 35.65 | 34.97 | 36.36 |
| Elongation @ yield, % | 10 | 10 | 9 |
| Elongation @ break, % | 71 | 65 | 74 |
| Flexural Strength @ yield, MPa | 44.48 | 44.14 | 46.67 |
| Flexural Modulus, 1% secant, MPa | 1428 | 1448 | 1531 |
| HDT @ 1.82 MPa, ° C. | 56 | 56 | 58 |
| HDT @ 0.46 MPa, ° C. | 93 | 100 | 110 |
| MFR@ 230° C., 3.8 kg., dg/min | 12 | 14 | 16 |

As is evident from the data in Table II, nanocomposite compositions containing the polymeric peroxide compatibilizing dispersants exhibit improved physical properties, as demonstrated by the higher flexural modulus and equivalent to better heat deflection properties in Example 6, and higher tensile strength, elongation at break, flexural strength and modulus and improved heat deflection properties in Example 7 as compared to the control composition without the polymeric peroxide.

Comparative Example 8 and Examples 9-12 demonstrate the use of a propylene polymeric peroxide compatibilizing dispersant in nanocomposite compositions containing montmorillonite clay and a propylene homopolymer commercially available from Basell USA Inc. The compositions and physical properties of Comparative Example 8 and Examples 9-12 are set forth in Table III.

TABLE III

| | Comp. Ex. 8 | Ex. 9 | Ex. 10 | Ex. 11 | Ex. 12 |
|---|---|---|---|---|---|
| Propylene homopolymer, | 96.8 | 86.8 | 86.8 | 86.8 | 86.8 |
| MFR = 4, I.I. = 95%, wt % | | | | | |
| PP-g-MA, wt % | | | | | 5.0 |
| Polymeric Peroxide of Example 1, wt % | | 10.0 | | | 5.0 |
| Acrylic Acid grafted polymeric | | | 10.0 | | |
| peroxide of Example 3, wt % | | | | | |
| Na⁺ ionomer of polymeric | | | | 10.0 | |
| peroxide of Example 4, wt % | | | | | |
| Clay A, wt % | 3.0 | 3.0 | 3.0 | 3.0 | 3.0 |
| FS210, wt % | 0.2 | 0.2 | 0.2 | 0.2 | 0.2 |
| Physical Properties | | | | | |
| Notched Izod Impact @ 23° C., J/cm | 0.37 | 0.43 | 0.37 | 0.37 | 0.27 |
| Tensile Strength @ yield, MPa | 35.65 | 36.36 | 35.81 | 35.54 | 35.87 |
| Elongation @ yield, % | 10 | 9 | 9 | 9 | 9 |
| Elongation @ break, % | 71 | 74 | 29 | 62 | 102 |
| Flexural Strength @ yield, MPa | 44.48 | 46.67 | 49.43 | 48.78 | 46.89 |
| Flexural Modulus, 1% secant, MPa | 1428 | 1531 | 1586 | 1552 | 1552 |
| HDT @ 1.82 MPa, ° C. | 56 | 58 | 60 | 56 | 59 |
| HDT @ 0.46 MPa, ° C. | 93 | 110 | 109 | 106 | 97 |
| MFR@ 230° C., 3.8 kg., dg/min | 12 | 16 | 15 | 17 | |

As is evident from the data in Table III, nanocomposite compositions containing 10 wt % of the polymeric peroxide compatibilizing dispersant, the acrylic acid grafted polymeric peroxide compatibilizing dispersant, and the 5 wt %/5 wt % blend of the polymeric peroxide compatibilizing dispersant and maleic anhydride grafted polypropylene, demonstrate an improved balance of properties relative to Comparative Example 8 that does not contain a polymeric peroxide compatibilizing dispersant. The Na⁺ ionomer polymeric peroxide compatibilizing dispersant demonstrates improved flexural strength, flexural modulus, and equivalent or better heat deflection temperatures relative Comparative Example 8.

Comparative Example 13 and Examples 14-16 demonstrate the use of a propylene polymeric peroxide, ionomer of a propylene polymer peroxide and acrylic acid grafted propylene polymeric peroxide compatibilizing dispersant in nanocomposite compositions containing montmorillonite clay and propylene homopolymers commercially available from Basell USA Inc. The compositions and physical properties of Comparative Example 13 and Examples 14-16 are set forth in Table IV.

TABLE IV

| | Comp. | | | |
|---|---|---|---|---|
| | Ex. 13 | Ex. 14 | Ex. 15 | Ex. 16 |
| Propylene homopolymer, MFR = | 96.8 | 86.8 | 86.8 | 86.8 |
| 4, I.I. = 95.0%, wt % | | | | |
| Polymeric Peroxide of Example 1, | | 10.0 | | |
| wt % | | | | |
| Acrylic Acid grafted polymeric | | | | 10.0 |
| peroxide of Example 3, wt % | | | | |
| Na⁺ ionomer of polymeric | | | 10.0 | |
| peroxide of Example 4, | | | | |
| wt % | | | | |
| Clay B, wt % | 3.0 | 3.0 | 3.0 | 3.0 |
| FS210, wt % | | 0.2 | 0.2 | 0.2 |
| Physical Properties | | | | |
| Notched Izod Impact @ 23° C., | 0.37 | 0.32 | 0.32 | 0.37 |
| J/cm | | | | |
| Tensile Strength @ yield, MPa | 33.74 | 33.22 | 33.93 | 35.92 |
| Elongation @ yield, % | 11 | 44 | 11 | 9 |
| Elongation @ break, % | 193 | 162 | 115 | 39 |
| Flexural Strength @ yield, MPa | 42.33 | 42.94 | 44.21 | 48.85 |
| Flexural Modulus, 1% secant, MPa | 1310 | 1324 | 1359 | 1531 |
| HDT @ 1.82 MPa, ° C. | 55 | 54 | 56 | 55 |
| HDT @ 0.46 MPa, ° C. | 92 | 88 | 94 | 96 |
| MFR@ 230° C., 3.8 kg., dg/min | 12 | 18 | | 16 |

As is evident from the data in Table IV, the composition containing 10 wt % of the polymeric peroxide compatibilizing dispersant demonstrates improved elongation at yield, flexural strength, and flexural modulus relative to Comparative Example 13 that does not contain a compatibilizing dispersant. The composition containing 10 wt % of the Na⁺ ionomer of the polymeric peroxide demonstrates improved tensile strength, flexural strength, flexural modulus, and equivalent or better heat deflection properties relative to Comparative Example 13 that does not contain a compatibilizing dispersant. The composition containing 10 wt % of the acrylic acid grafted polymeric peroxide demonstrates improved tensile strength, flexural strength and modulus, and equal to improved heat deflection properties, relative to Comparative Example 13 that does not contain a compatibilizing dispersant.

Transmitted light microscopy was performed on microtomed sections cut from injection-molded tensile bar samples, to evaluate clay dispersion in nanocomposite compositions. Transmitted light microscopy photographs of propylene polymer nanocomposite compositions, taken with an optical microscope commercially available from Leitz Aristomet, are shown in FIGS. 1-2. These figures demonstrate that propylene polymer nanocomposite compositions containing polymeric peroxide compatibilizing dispersants (FIG. 2, Example 7) enhanced clay dispersion as compared to a propylene polymer nanocomposite composition without any compatibilizer or dispersant (FIG. 1, Comparative Example 5).

Cross-polarized light images were taken of microtomed sections cut from tensile bar samples to evaluate crystalline morphology, as shown in FIGS. 3-4. The cross-polarized photographs were taken with an optical microscope commercially available from Leitz Aristomet. The Figures demonstrate that the combination of smectite clay and compatibilizing dispersants serve as a mild nucleating agent for propylene polymer material, as shown by the reduction in spherulite size (FIG. 4, Example 7), relative to Comparative Example 5 (FIG. 3).

Conventional differential scanning calorimeter (“DSC”) scans were conducted on specimens cut from injection-molded tensile bars to evaluate crystallization temperatures using a DSC 2920 differential scanning calorimeter commercially available from TA Instruments. The temperature scan range was set between 25 and 235° C., and the scan rate was 20° C./min. The DSC scans are shown in FIG. 5 for nanocomposite compositions containing the polymeric peroxide compatibilizing dispersant of Example 7 (curve 1), and the polymeric peroxide/maleated propylene polymer mixture of Example 12 (curve 3), relative to the composition containing no maleated propylene polymer material or polymeric peroxide of Comparative Example 5 (curve 2). FIG. 5 demonstrates differences in the cooling scans for the composition curves. The crystallization peak temperature in the cooling scan varied from 120° C. for Example 7 (curve 1), to 117° C. for Comparative Example 5 (curve 2) and 110° C. for Example 12 (curve 3). These results confirm the observations from the cross-polarized light images, that the combination of the compatibilizing dispersants and smectite clay enhance the nucleation of the propylene polymer material, while the use of maleated propylene polymer material suppresses the nucleation of the propylene polymer material.

Other features, advantages and embodiments of the invention disclosed herein will be readily apparent to those exercising ordinary skill after reading the foregoing disclosures. In this regard, while specific embodiments of the invention have been described in considerable detail, variations and modifications of these embodiments can be effected without departing from the spirit and scope of the invention as described and claimed.

1. A polyolefin nanocomposite composition comprising:
A. 5 to 20 wt % of a compatibilizing dispersant chosen from an olefin polymer peroxide, an ionomer of an olefin polymer peroxide, a grafted olefin polymer peroxide, and mixtures thereof;
B. 1 to 15 wt % of a smectite clay; and
C. 65 to 94 wt % of an olefin polymer material;
wherein the sum of components A+B+C is equal to 100 wt %.

2. The composition of claim 1 comprising
A. 7 to 15 wt % of the compatibilizing dispersant;
B. 2 to 10 wt % of the smectite clay; and
C. 75 to 91 wt % of the olefin polymer material.

3. The composition of claim 1 wherein a starting material for preparing the compatibilizing dispersant A is chosen from propylene polymers, ethylene polymers, butene-1 polymers and mixtures thereof.

4. The composition of claim 1 wherein the olefin polymer material C is chosen from propylene polymers, ethylene polymers, butene-1 polymers and mixtures thereof.

5. The composition of claim 3, wherein the propylene polymers are chosen from:
(a) a homopolymer of propylene having an isotactic index greater than 80%;
(b) a random copolymer of propylene and an olefin chosen from ethylene and C₄-C₁₀ α-olefins, containing 1 to 30 wt % of the olefin, and having an isotactic index greater than 60%;
(c) a random terpolymer of propylene and two olefins chosen from ethylene and C₄-C₈ α-olefins, containing 1 to 30 wt % of the olefins, and having an isotactic index greater than 60%;
(d) an olefin polymer composition comprising:
(i) 10 parts to 60 parts by weight of a propylene homopolymer having an isotactic index of at least 80%, or a crystalline copolymer chosen from (a) propylene and ethylene, (b) propylene, ethylene and a C₄-C₈ α-olefin, and (c) propylene and a C₄-C₈ α-olefin, the copolymer having a propylene content of more than 85% by weight, and an isotactic index greater than 60%;
(ii) 3 parts to 25 parts by weight of a copolymer of ethylene and propylene or a C₄-C₈ α-olefin that is insoluble in xylene at ambient temperature; and
(iii) 10 parts to 80 parts by weight of an elastomeric copolymer chosen from (a) ethylene and propylene, (b) ethylene, propylene, and a C₄-C₈ α-olefin, and (c) ethylene and a C₄-C₈ α-olefin, the copolymer optionally containing from 0.5% to 10% by weight of a diene, and containing less than 70% by weight of ethylene, and being soluble in xylene at ambient temperature and having an intrinsic viscosity of 1.5 to 4.0 dl/g;
the total of (ii) and (iii), based on the total olefin polymer composition being from 50% to 90%, and the weight ratio of (ii)/(iii) being less than 0.4, wherein the composition is prepared by polymerization in at least two stages;
(e) a thermoplastic olefin comprising:
(i) 10% to 60% of a propylene homopolymer having an isotactic index of at least 80%, or a crystalline copolymer chosen from (a) ethylene and propylene, (b) ethylene, propylene and a C₄-C₈ α-olefin, and (c) ethylene and a C₄-C₈ α-olefin, the copolymer having a propylene content greater than 85% and an isotactic index of greater than 60%;
(ii) 20% to 60% of an amorphous copolymer chosen from (a) ethylene and propylene, (b) ethylene, propylene, and a C₄-C₈ α-olefin, and (c) ethylene and a α-olefin, the copolymer optionally containing from 0.5% to 10% of a diene, and containing less than 70% ethylene and being soluble in xylene at ambient temperature; and
(iii) 3% to 40% of a copolymer of ethylene and propylene or an α-olefin that is insoluble in xylene at ambient temperature; and
(f) mixtures thereof.

6. The composition of claim 4, wherein the propylene polymers are chosen from:
(a) a homopolymer of propylene having an isotactic index greater than 80%;
(b) a random copolymer of propylene and an olefin chosen from ethylene and C₄-C₁₀ α-olefins, containing 1 to 30 wt % of the olefin, and having an isotactic index greater than 60%;
(c) a random terpolymer of propylene and two olefins chosen from ethylene and C₄-C₈ α-olefins, containing 1 to 30 wt % of the olefins, and having an isotactic index greater than 60%;
(d) an olefin polymer composition comprising:
(i) 10 parts to 60 parts by weight of a propylene homopolymer having an isotactic index of at least 80%, or a crystalline copolymer chosen from (a) propylene and ethylene, (b) propylene, ethylene and a C₄-C₈ α-olefin, and (c) propylene and a C₄-C₈ α-olefin, the copolymer having a propylene content of more than 85% by weight, and an isotactic index greater than 60%;
(ii) 3 parts to 25 parts by weight of a copolymer of ethylene and propylene or a C₄-C₈ α-olefin that is insoluble in xylene at ambient temperature; and
(iii) 10 parts to 80 parts by weight of an elastomeric copolymer chosen from (a) ethylene and propylene, (b) ethylene, propylene, and a C₄-C₈ α-olefin, and (c) ethylene and a C₄-C₈ α-olefin, the copolymer optionally containing from 0.5% to 10% by weight of a diene, and containing less than 70% by weight of ethylene, and being soluble in xylene at ambient temperature and having an intrinsic viscosity of 1.5 to 4.0 dl/g;
the total of (ii) and (iii), based on the total olefin polymer composition being from 50% to 90%, and the weight ratio of (ii)/(iii) being less than 0.4, wherein the composition is prepared by polymerization in at least two stages;
(e) a thermoplastic olefin comprising:
(i) 10% to 60% of a propylene homopolymer having an isotactic index of at least 80%, or a crystalline copolymer chosen from (a) ethylene and propylene, (b) ethylene, propylene and a C₄-C₈ α-olefin, and (c) ethylene and a C₄-C₈ α-olefin, the copolymer having a propylene content greater than 85% and an isotactic index of greater than 60%;
(ii) 20% to 60% of an amorphous copolymer chosen from (a) ethylene and propylene, (b) ethylene, propylene, and a C₄-C₈ α-olefin, and (c) ethylene and a α-olefin, the copolymer optionally containing from 0.5% to 10% of a diene, and containing less than 70% ethylene and being soluble in xylene at ambient temperature; and
(iii)₃% to 40% of a copolymer of ethylene and propylene or an α-olefin that is insoluble in xylene at ambient temperature; and
(f) mixtures thereof.

7. The composition of claim 3, wherein the ethylene polymers are chosen from:
(a) homopolymers of ethylene;
(b) random copolymers of ethylene and an alpha-olefin chosen from C₃₋₁₀ alpha-olefins;
(c) random terpolymers of ethylene and C₃₋₁₀ alpha-olefins; and
(d) mixtures thereof.

8. The composition of claim 4, wherein the ethylene polymers are chosen from:
(a) homopolymers of ethylene;
(b) random copolymers of ethylene and an alpha-olefin chosen from C₃₋₁₀ alpha-olefins;
(c) random terpolymers of ethylene and C₃₋₁₀ alpha-olefins; and
(e) mixtures thereof.

9. The composition of claim 3, wherein the butene-1 polymers are chosen from:
(a) homopolymers of butene-1;
(b) copolymers or terpolymers of butene-1 with a non-butene alpha-olefin comonomer content from 1 to 15 mole %; and
(c) mixtures thereof.

10. The composition of claim 4, wherein the butene-1 polymers are chosen from:
(a) homopolymers of butene-1;
(b) copolymers or terpolymers of butene-1 with a non-butene alpha-olefin comonomer content from 1 to 15 mole %; and
(c) mixtures thereof.

11. The composition of claim 1 wherein the smectite clay B is chosen from montmorillonite, nontronite, beidellite, volkonskoite, hectorite, saponite, sauconite, sobockite, stevensite, svinfordite and mixtures thereof.

12. The composition of claim 11 wherein the smectite clay B is montmorillonite.

13. The composition of claim 1 wherein the compatibilizing dispersant A is an olefin polymer peroxide containing greater than 1 mmol total peroxide per kilogram of the olefin polymer peroxide.

14. The composition of claim 1 wherein the compatibilizing dispersant A is a sodium ionomer of an olefin polymer peroxide.

15. The composition of claim 1 wherein the compatibilizing dispersant A is a grafted olefin polymer peroxide.

16. The composition of claim 15 wherein the grafted olefin polymer peroxide is grafted with a monomeric vinyl compound wherein a vinyl radical, CH₂═CHR—, in which R is H or methyl, is attached to a straight or branched aliphatic chain having 2-12 carbon atoms or to a substituted or unsubstituted aromatic compound having 6-20 carbon atoms, heterocyclic compound having 4-20 carbon atoms, or alicyclic ring compound having 3-20 carbon atoms in a mono or polycyclic compound.

17. The composition of claim 16 wherein the monomeric vinyl compound is chosen from acrylic acid, methacrylic acid, maleic acid, maleic anhydride, vinyl-substituted aromatic compound having 6-20 carbon atoms, vinyl-substituted heterocyclic compound having 4-20 carbon atoms, vinyl-substituted alicyclic compound having 3-20 carbon atoms and mixtures thereof.

18. The composition of claim 17 wherein the monomeric vinyl compound is acrylic acid.

19. The composition of claim 1 wherein the smectite clay B is treated with a quaternary ammonium salt.

20. A shaped article comprising the composition of claim 1.
